(19) United States
(12) Patent Application Publication
(10) Pub. No.: US 2023/0365130 A1
(43) Pub. Date: Nov. 16, 2023

(54) REAR APPROACHING VEHICLE DETECTING AND WARNING DEVICE

(71) Applicant: TRIOFORCE INTERNATIONAL INC., New Taipei City (TW)

(72) Inventors: FENG-CHENG CHEN, New Taipei City (TW); CHENG-HSIUNG LU, New Taipei City (TW); CHIA-SHENG SUNG, New Taipei City (TW); CHAO-HUANG CHEN, New Taipei City (TW); TZU-YU LIN, New Taipei City (TW); YI-CHIEH CHANG, New Taipei City (TW)

(21) Appl. No.: 17/744,137

(22) Filed: May 13, 2022

(51) Int. Cl. B60W 30/095; B60W 50/14

(52) U.S. Cl. CPC B60W 30/0956; B60W 30/0953; B60W 50/14; B60W 2554/4049; B60W 2300/36; B60W 2510/18; B60W 2050/143

(57) ABSTRACT

A rear approaching vehicle detecting and warning device comprises a detecting device installed at an appropriate position behind a motorbike body, a signal processing module, and a riding safety component capable of being assembled on handlebars of the motorbike. The detecting device is provided with a sensing module, a control circuit, and a signal transmitting module. The sensing module senses a vehicle approaching around to generate a detection signal. The signal transmitting module receives the detection signal through the control circuit and then transmits the detection signal. The signal processing module is used for receiving and processing the detection signal transmitted by the signal transmitting module to generate a warning signal. The riding safety component is provided with a light module and electrically connected to the signal processing module. The riding safety component is used for receiving the warning signal to display on the light module.

### FIELD OF THE INVENTION

The present invention is related to a rear approaching vehicle detecting and warning device, which is simple in structure, easy to assemble and low in cost, and the safety of riding can be improved, especially suitable for installation on various kinds of motorbike or electric scooters.

### BACKGROUND OF THE INVENTION

With the rise of international oil prices, motorbikes that are fuel-saving, environmentally friendly, energy-saving and carbon-reducing have always been popular goods due to the convenience of traversing between streets and their mobility. In addition, with the change in lifestyle, people pay more and more attention to leisure sports. The natural environment such as countryside and suburbs has become people's new favorite. It is also very common to use motorbikes as leisure vehicles or for off-road sports, etc.

The safety equipment of motorbikes is also constantly improved. For example, anti-lock brake system (ABS) installation and using disc brakes on both front and rear wheels keep improving the safety and practicability of motorbikes. The more common safety equipment, such as balance terminals with counterweight assembled on the ends of the handlebars, not only makes the motorbikes more stable, not easy to shake or assist in suppressing the front wheel shake, etc., but also increases the visual appearance and the grip feel. In addition, combining a handguard that can protect the hands of the rider on the handlebars, or installing a terminal mirror on the handlebars, etc., is also very common safety configurations on heavy motorcycles.

However, in the existing motorbike safety equipment, there is no such a car-like design such as blind spot detection for detecting a vehicle approaching from behind. Although there is the structure for viewing the rear, such as a pair of left and right rear mirrors or terminal mirrors, it does not have a mechanism to remind when a vehicle is approaching from behind. And the rear view range and the angle are very limited. Even when the rider judges that the rear object is approaching through the rear mirrors, it cannot fully reflect the actual approaching distance of the rear object. Hence, it often causes the rider to be too late to react, resulting in the danger of a collision. Therefore it needs to be improved.

### SUMMARY OF THE INVENTION

Therefore, in order to solve the existing problems of how to provide a car-like warning effect when a vehicle approaches from behind has always been the research direction of the inventor.

The main object of the present invention is to provide a rear approaching vehicle detecting and warning device, which is simple in structure, easy to assemble and low in cost, and the safety of riding can be improved, especially suitable for installation on various kinds of motorbike or electric scooters.

In order to achieve the above object, the present invention provides a rear approaching vehicle detecting and warning device which comprises a detecting device, a signal processing module, and a riding safety component capable of being assembled on a pair of left and right handlebars of a motorbike. The detecting device is installed at an appropriate position behind a body of the motorbike. The detecting device is provided with at least a sensing module, a control circuit, and a signal transmitting module, wherein when the sensing module senses a vehicle approaching around, the sensing module generates a detection signal. The signal transmitting module receives the detection signal through the control circuit and then transmits the detection signal. The signal processing module is used for receiving and processing the detection signal transmitted by the signal transmitting module to generate a warning signal. The riding safety component is provided with a light module. The riding safety component is electrically connected to the signal processing module. The riding safety component is used for receiving the warning signal to display on the light module.

In implementation, the signal processing module is buried in the pair of left and right handlebars of the motorbike.

In implementation, the riding safety component capable of being assembled on the pair of left and right handlebars of the motorbike is a balance terminal, a terminal mirror, or a handguard.

In implementation, the detecting device and the signal processing module are connected to a power supply module, respectively.

For further understanding the characteristics and effects of the present invention, some preferred embodiments referred to drawings are in detail described as follows.

### BRIEF DESCRIPTION OF DRAWINGS

FIG. 1 is an architectural diagram of a rear approaching vehicle detecting and warning device of the present invention.

FIG. 2 is a detailed architectural diagram of a rear approaching vehicle detecting and warning device of the present invention.

FIG. 3 is a schematic diagram of the appearance of an embodiment of the present invention when a balance terminal is used.

FIG. 4 is a schematic diagram of the appearance of an embodiment of the present invention when a terminal mirror is used.

FIG. 5 is a schematic diagram of the appearance of a motorbike of an embodiment of the present invention when a terminal mirror is used.

FIG. 6 is a schematic diagram of the appearance of an embodiment of the present invention when a handguard is used.

### DETAILED DESCRIPTIONS OF PREFERRED EMBODIMENTS

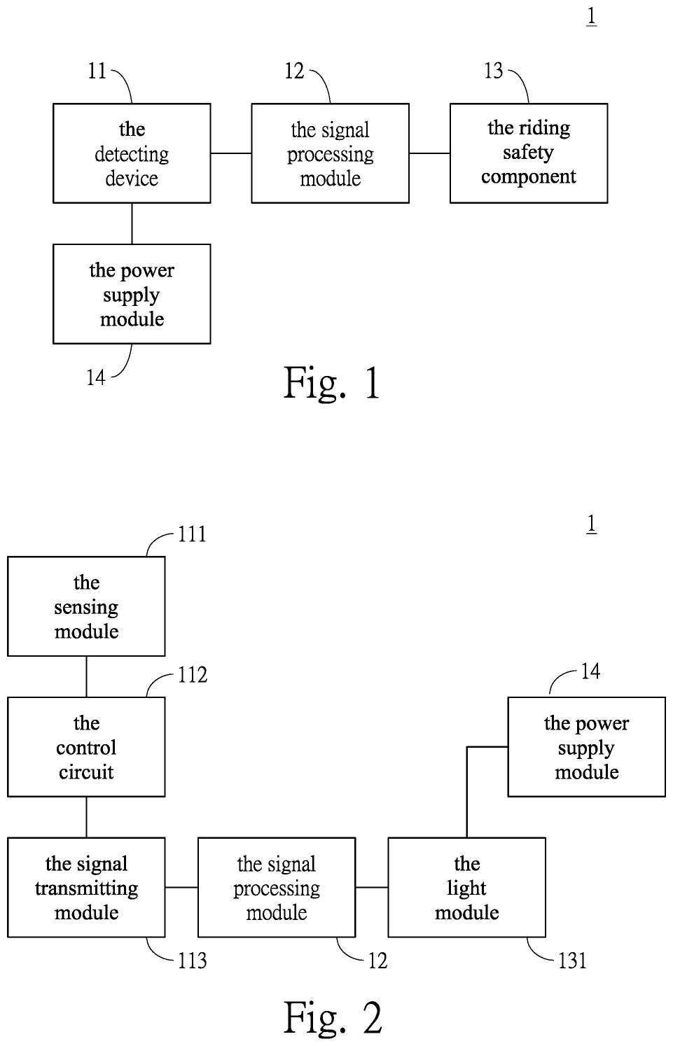

Please refer to FIGS. 1-6, which show an embodiment of a rear approaching vehicle detecting and warning device 1 of the present invention. Taking an example that the rear approaching vehicle detecting and warning device 1 is installed on a motorbike 2, the rear approaching vehicle detecting and warning device 1 is used for warning when a vehicle approaching from behind the motorbike 2. A rear approaching vehicle detecting and warning device 1 provided by the present invention comprises a detecting device 11, a signal processing module 12, and a riding safety component 13 capable of being assembled on a pair of left and right handlebars 21 of the motorbike 2.

The detecting device 11 is installed at an appropriate position behind a body of the motorbike 2. The detecting device 11 is provided with at least a sensing module 111, a control circuit 112, and a signal transmitting module 113, wherein when the sensing module 111 senses a vehicle approaching around, the sensing module 111 generates a detection signal. The signal transmitting module 113 receives the detection signal through the control circuit 112 and then transmits the detection signal.

The signal processing module 12 is used for receiving the detection signal transmitted by the signal transmitting module 113 to generate a warning signal. In implementation, the signal processing module 12 is capable of being assembled and hidden in the pair of left and right handlebars 21 of the motorbike 2.

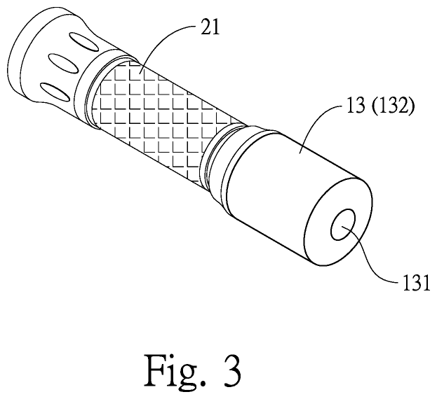

The riding safety component 13 is provided with a light module 131. The riding safety component 13 is electrically connected to the signal processing module 12. The riding safety component 13 is used for receiving the warning signal to display on the light module 131. The riding safety component 13 capable of being assembled on the pair of left and right handlebars 21 of the motorbike 2 may be a balance terminal 132, a terminal mirror 133, or a handguard 134 (as shown in FIGS. 3-6).

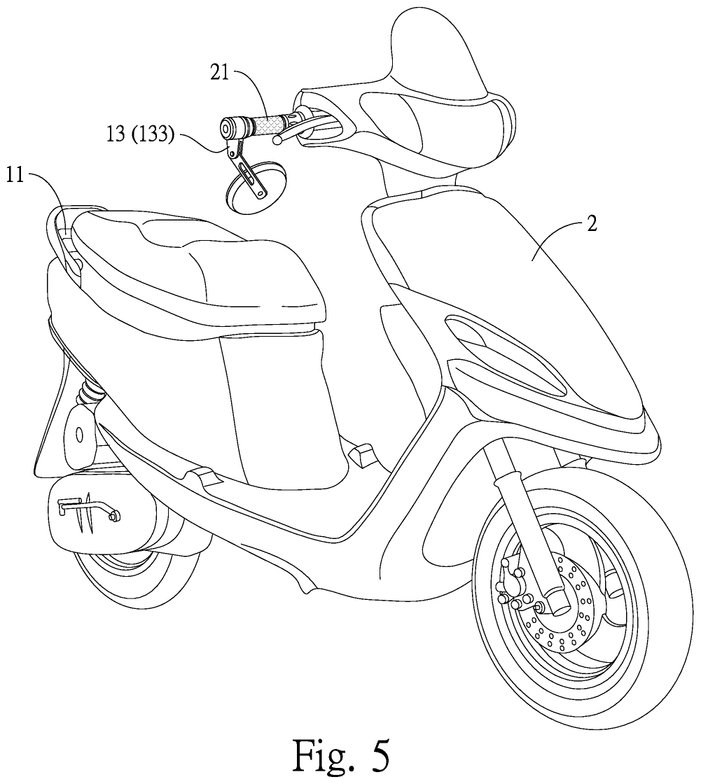

In implementation, the detecting device 11 and the light module 131 are connected to a power supply module 14, respectively. The power supply module 14 may be a battery module or a circuit device connected to a mobile power supply. The detecting device 11 may be installed at the position under the seat cushion, on the shelf behind the body of the motorbike 2, on the license plate or other convenient position (as shown in FIG. 5), and the detecting device 11 can face the rear of the body of the motorbike 2 and detect without being shielded.

Hence, taking an example that the riding safety component 13 is a balance terminal 132 (as shown in FIG. 3), the light module 131 may be installed on the balance terminal 132. Hence, when the detecting device 11 installed behind the body of the motorbike 2 is activated and senses an object approaching from behind the body of the motorbike 2 (such as a vehicle approaching from behind), a detection signal is generated and then transmitted to the warning device 12 to be derived to generate a warning signal, then the warning signal is displayed on the light module 131 installed on the balance terminal 132. Therefore, a rider can directly see the warning signal on the balance terminal 132 of the handlebars 21, so as to make immediate reactions such as decelerating, accelerating or changing lanes.

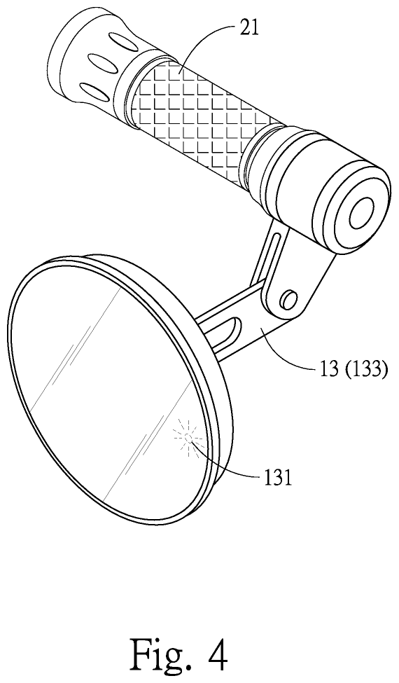

While taking an example that the riding safety component 13 is a terminal mirror 133 (as shown in FIGS. 4 and 5), the light module 131 may be installed on the terminal mirror 133. In the same way as described above, when the light module 131 on the terminal mirror 133 receives the warning signal, the rider can directly see the warning signal on the terminal mirror 133 of the handlebars 21, so as to make immediate reactions such as decelerating, accelerating, or changing lanes.

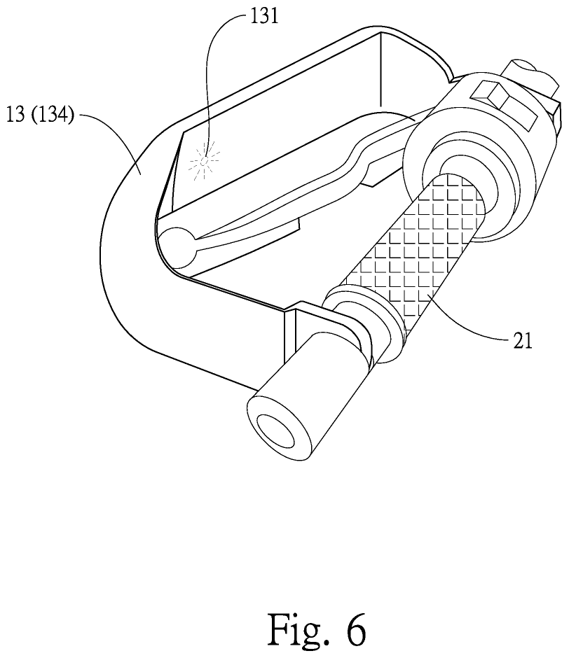

Similarly, taking an example that the riding safety component 13 is a handguard 134 (as shown in FIG. 6), when the light module 131 on the handguard 134 receives the warning signal, the rider can directly see the warning signal on the handguard 134 of the handlebars 21, so as to make immediate reactions such as decelerating, accelerating, or changing lanes.

Thereby, the design of the present invention has following advantages:
1. Through the structure design of the rear approaching vehicle detecting and warning device of the present invention, the rider can quickly know whether there is a vehicle approaching and the warning effect by simply looking at the riding safety component on the handlebars, so that the safety of riding can be effectively improved.
2. The design of the present invention is simple in structure, low in cost and easy to assemble, and the light module can be assembled on various riding safety components suitable for combination on the handlebars which can be achieved without changing the existing body of the motorbike and without affecting the sightline ahead of the rider.

As disclosed in the above description and attached drawings, the present invention can provide a rear approaching vehicle detecting and warning device. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A rear approaching vehicle detecting and warning device, which is used for warning when a vehicle approaching from behind a motorbike, said rear approaching vehicle detecting and warning device comprises:
a detecting device installed at an appropriate position behind a body of said motorbike, and said detecting device being provided with at least a sensing module, a control circuit, and a signal transmitting module, wherein when said sensing module senses a vehicle approaching around, said sensing module generates a detection signal, and said signal transmitting module receives said detection signal through said control circuit and then transmits said detection signal;
a signal processing module used for receiving and processing said detection signal transmitted by said signal transmitting module to generate a warning signal; and
a riding safety component capable of being assembled on a pair of left and right handlebars of said motorbike, and said riding safety component being provided with a light module, said riding safety component is electrically connected to said signal processing module, and said riding safety component is used for receiving said warning signal to display on said light module.

2. The rear approaching vehicle detecting and warning device according to claim 1, wherein said signal processing module is buried in said pair of left and right handlebars of said motorbike.

3. The rear approaching vehicle detecting and warning device according to claim 2, wherein said riding safety component capable of being assembled on said pair of left and right handlebars of said motorbike is a balance terminal, a terminal mirror, or a handguard.

4. The rear approaching vehicle detecting and warning device according to claim 1, wherein said riding safety component capable of being assembled on said pair of left and right handlebars of said motorbike is a balance terminal, a terminal mirror, or a handguard.

5. The rear approaching vehicle detecting and warning device according to claim 1, wherein said detecting device and said signal processing module are connected to a power supply module, respectively.
